(19) United States
(12) Patent Application Publication
(10) Pub. No.: US 2020/0114610 A1
(43) Pub. Date: Apr. 16, 2020

(54) FILLING APPARATUS FOR A TABLETING MACHINE

(71) Applicant: KORSCH AG, Berlin (DE)

(72) Inventors: Ingo KLAER, Berlin (DE); Stephan MIES, Berlin (DE)

(21) Appl. No.: 16/615,686

(22) PCT Filed: Jul. 17, 2018
(86) PCT No.: PCT/IB2018/055269

§ 371 Date: Nov. 21, 2019

(30) Foreign Application Priority Data
May 24, 2017 (EP) 17172617.7
Oct. 26, 2017 (EP) 17198467.7

(51) Int. Cl. B30B 15/30; B30B 11/08

(52) U.S. Cl. CPC B30B 15/304; B30B 11/08

(57) ABSTRACT

The invention relates to a filling device for a tabletting machine comprising a covering device and a cone, wherein a gap is formed between the covering device and the cone, said gap being adapted to guide tabletting material from a filling tube of the filling device into a region of die openings of a die table.

The invention concerns a filling apparatus for a tabletting machine comprising a covering device, a cone, and a gap between the covering device and the cone, said gap being designed to guide tabletting material from a filling tube of the filling apparatus into a region where a die table has die openings.

### STATE OF THE ART

In the case of state of the art tabletting machines, it is necessary that the material to be tableted, which in the sense of the invention is preferably referred to as tabletting material or powder to be pressed, is transported from a material feeder into the area of the die table so that it can reach the die holes or die openings where it is pressed into pellets. Pressing is usually carried out by the upper and lower punches moving into the die holes or die openings and compressing the material located there. The filling process is usually carried out in such a way that the lower punch is located in the die bore or die opening, the material is filled into the bore or opening from above, the lower punch is moved upwards by a certain distance and the material protruding from the die opening over the surface of the die table is scraped off. The filling of the material is usually carried out in such a way that the material from a storage chamber for the powder to be pressed is guided by means of the filling device to the die holes or die openings, so that these are filled one after the other with the tabletting material. It should be noted that this usually occurs at high rotational speeds of the rotor.

The state of the art is particularly well known for filling devices in which the tabletting material is transferred from the storage chamber to the area of the die table by heavy force acting in the direction of the ground. A disadvantage of this type of filling, however, is that particularly at high rotational speeds of the rotor carrying the die table, filling may no longer be constant and homogeneous. In addition to this, there are tabletting materials which, due to their consistency and properties, are not suitable for gravity-induced filling into the die bores and openings, as these materials tend to stick together or have very poor filling and/or flow properties.

In order to meet these challenges, state-of-the-art filling devices with agitator blades or impellers have become known, in which the tabletting material in the filling device can be distributed homogeneously by means of the agitator blades and/or impellers and guided into the area of the die table. When such mixing and/or guiding devices are used, however, the tabletting powder may be ground undesirably, resulting in a change in the consistency of the powder or other mechanical stresses on the material to be pressed, which can have a negative effect on the manufacture or quality of the pellets.

It is therefore the task of the present invention to provide a filling device that does not have the disadvantages and shortcomings of the state of the art and at the same time enables a smooth, uncomplicated material feed and can be easily integrated into existing structures of tabletting machines, i.e. with as few additional components as possible. In addition, the invention-based filling device should require little space and be easy to clean.

### DESCRIPTION OF THE INVENTION

The task is solved by the characteristics of the claim 1. Advantageous embodiments of the invention are described in the dependent claims. A filling device comprising a covering device and a cone is provided, wherein a gap is formed between the covering device and the cone, the gap being adapted to guide tabletting material from a filling tube of the filling device into a region of die bores of a die table, wherein the covering device is rotatably formed and the tabletting machine comprises drive means for generating the rotational movement of the covering device.

In the sense of the invention, a filling device can preferably also be referred to as a filling shoe, the covering device also preferably as a lid or funnel. These terms are preferably used synonymously in the sense of the invention. It is preferred that the lid closes the filling shoe upwards in the direction in space, wherein the direction in space “upwards” in the sense of the invention represents the direction in space pointing away from the ground, while the term “downwards” preferably describes the direction in space pointing towards the ground. Preferably, the powder material to be pressed is filled into the filling shoe through a filling tube, whereby the filling tube preferably does not rotate and/or move, in other words stands still in the room. The cover or covering device is rotatable, the tabletting machine comprising drive means for generating the rotary movement of the cover. If the press material in the filling tube tends to bridge, it may be preferable in the sense of the invention for the filling tube to rotate together with the lid. A preferably stationary rod can then be arranged inside the tube, which is preferably attached to the inlet funnel of the press. It may be preferred in the sense of invention that the rod includes chicane. As a result, any bridges in the press material can be broken up and the press material can flow smoothly into the filling shoe.

A particular advantage of the invention is that the filling device has no impeller and no agitator blade. This is achieved advantageously by the rotatability of the lid. Due to the absence of impellers, an undesirable mechanical grinding of the pellet powder is avoided particularly effectively, for example by reducing possible grinding points. This enables particularly gentle processing of the powder and ensures that the powder reaches the dies with the desired consistency and sufficient quantity. The avoidance of an impeller or an agitator blade represents in particular a departure from the conventional operating principle of state-of-the-art filling devices for tabletting machines. In particular, experts had previously assumed that an impeller and/or an agitator blade in a filling device for tabletting machines could not be dispensed with. The rotatably designed, preferably conical, lid advantageously provides the functionalities of conventional filling devices and in particular conveys the powder material evenly, homogeneously and gently from the filling tube through the gap between lid and cone to the die bores and openings. This transport is advantageously carried out with minimal friction on the press material, this advantage being ensured in particular by the preferably smooth surfaces of the cone and the rotatability of the cover.

The preferably funnel-shaped design of the lid is preferably realised in such a way that the funnel has a smaller diameter in an upper area, in which, for example, also the filling tube merges, than in a lower area, which, for example, faces the die table and/or the rotor.

A tabletting machine in the sense of the invention is, for example, a tablet press. But it also refers to all other devices which can be used in general for the production of tablets or pellets. In the sense of the invention, the “pellet” includes not only tablets but also dragees, capsules, sweets, dishwasher tabs, pellets made of coffee or pellets made of chemical substances, for example for the production of batteries and/or accumulators.

The filling device comprises a cone which is preferably located centrally inside the filling device and which, in the sense of the invention, is preferably referred to as a cone. The term “cone” in the sense of the invention refers preferably to a surface of rotation formed by a curve rotating around an axis. For the purposes of this invention, it is particularly preferable that the term designates a technical component which preferably has the shape of a cone. In the sense of the invention, it is particularly preferable to describe the change in the diameter of a cone as conicity.

It is particularly preferred that these drive means are located above and/or below the filling device. They may, for example, be formed by a gear drive and/or a belt drive, these preferred configurations of the invention being preferred in particular when the drive device is located above the covering device of the filling device.

It is preferred in a preferred embodiment of the invention that the cone comprises a cone tip and the filling tube of a material feed is centrally located above the cone tip. It may also be preferred in the sense of the invention that the filling tube is arranged centrally with respect to an inlet opening of the covering device. These preferred embodiments of the invention result in a particularly homogeneous distribution of the press material within the filling device, which also promotes uniform filling of the die holes or openings in the die table.

In the sense of the invention, it is preferred that the pressing material enters the filling shoe, wherein the lid of the filling shoe rotates and a gap is formed between the lid and the cone inside the filling shoe, through which the powder material to be pressed is guided to the die openings. It is preferable that the covering device comprises guiding means on its inside adapted to guide the tabletting material within the gap between the covering device and the cone. Preferably the guiding means are not connected to the drive shaft. The guiding means also rotate, preferably due to the rotation of the lid, and thus contribute advantageously to the conveyance of the powder material within the filling device. The guiding means are preferably designed in such a way that the powder material is mixed particularly gently and conveyed in the direction of the die table.

It is preferred, in another embodiment of the invention, that the drive device is located below the filling device. This preferred design of the invention has the advantage of requiring little space, advantageously due to the compact design of the filling device due to its arrangement. For example, with such a filling device design, covering devices with smaller diameters can be used. It is also characterised by a small number of components that are not particularly maintenance-intensive or have to be made ready for operation, for example by lubricating the components. In particular, this makes it possible to dispense with an additional covering of the drive means in order to avoid any contamination.

It is preferred that the filling device comprises a drive shaft which is arranged to transmit the rotary motion of the drive to the covering device. The drive shaft is preferably stimulated to rotate, which is transmitted to the lid of the filling device so that it rotates. For example, the drive shaft may preferably be driven directly by a motor as part of the filling system or device, or by an additional bearing housing which is preferably not part of the filling device. In another embodiment of the invention, it is preferred, that the filling device comprises a bearing housing for mounting the covering device. In particular, the bearing arrangement can be closed or open, whereby in particular a roller bearing arrangement, a deep groove ball bearing arrangement and/or an external bearing arrangement can also be considered. In particular, the bearing arrangement is designed to support the lid in a suitable manner, irrespective of whether the drive means driving the rotatable lid to rotate are located above or below of the filling device. Preferably the bearing has play and effectively prevents the drive shaft from moving up and/or down. In particular, a free of play elimination of the bearing clearance is advantageously achieved by the suitable bearing arrangement of the covering device.

It may also be preferable for the filling device to comprise its own motor connected to the drive shaft by means of a cardan shaft, where its own motor may, for example, also be part of the drive shaft and/or where the motor is part of the filling device.

The rotation of the drive shaft is preferably transmitted by coupling means, the covering device and the drive shaft being connected to each other by coupling means. It is preferred that the coupling means are fixed to the inside of the cover as well as to the drive shaft and that these two components are rigidly connected to each other. This allows the cover to follow the rotation of the drive shaft, with the drive shaft and cover rotating in the same direction. The coupling means can, for example, be one-piece or multi-piece. In particular, they must not be confused with agitator blades, but serve to connect the drive shaft to the hopper in order to transfer the rotary motion of the drive shaft to the hopper.

The coupling means can, for example, be formed by connecting bars, which are preferably located between the drive shaft and the cover. For example, three or four connecting bars can be used, where these bars are preferably narrow and have a streamlined cross-section to minimize their flow resistance. In the sense of the invention, it is in particular preferable to arrange the bars vertically in order to keep the contact between pressing material and coupling means as low as possible.

In a further embodiment of the invention, the cone is formed at least in two parts, the cone comprising at least a truncated cone and a cone tip. In this design it is preferred that the truncated cone and the cone tip and possibly other cone components are separated from each other in such a way that each component can be moved independently of other cone components. Preferably, a cone component located between a cone tip and a truncated cone is referred to as a cone disc in the terms of the invention. In the terms of the invention, it is particularly preferable that the cone tip is designed to be rotatable, wherein the cone tip in particular is then connected to the rotatable drive shaft by the coupling means in order to transfer the rotary movement of the drive shaft to the cone tip. In other words, it is preferred that the cone tip is connected to the drive shaft, so that the cone tip rotates preferably in the same direction as the covering device. It is preferred that the truncated cone is static, i.e. it is not designed to make a rotating movement.

It is preferred in the sense of the invention that the cone comprises different sections, whereby the different sections have different cross-sections and/or angles of inclination, whereby different pressure ratios can be produced at different locations in the gap between the covering device and the cone, and allows pressure loading or pressure relief of the tableting material. Preferably the sections can be the truncated cone and the tip of the cone. The term “angle of inclination”, in the terms of the invention, means preferably the angle enclosed by the outer edge of the cone section and an imaginary base area of that section. It is preferable that the angle of inclination lies in a preferred range between 30 and 75°, whereby the tip of the cone, for example, may have a larger angle of inclination than the truncated cone or any cone sections lying in between.

The term “cross section” means, in the terms of the invention, that the cone sections can be differently shaped in the side view, for example by having different helix angles. The angle of inclination is determined in particular by the upper and lower outside diameters of the cone sections, it being particularly preferable, for the purposes of the present invention, that the upper diameters are smaller than the lower diameters. The term upper outer diameter in the terms of the invention refers preferably to the outer diameter of a cone section at its upper end, while the term lower outer diameter describes preferably the outer diameter of the cone section in the area of the imagined base area. In the terms of the invention, it is further preferred that the average outside diameter of the truncated cone is larger than the average outside diameter of the cone tip and/or the cone discs, which may be present. The term average outside diameter, in the sense of the invention, refers preferably to the mean value between the upper and lower outside diameters of a cone section. For example, the outside diameter of the cone sections can be in a preferred range from 30 to 150 mm; however, depending on the application in different tabletting machines, other outside diameters can also be preferred.

The preferential provision of variable angles of inclination and/or cross-sections with respect to the individual cone sections is particularly advantageous because it enables pressure relief of the powder material within the filling device. This pressure relief is particularly adjustable by the variable angles of inclination and/or cross sections, so that the cone sections can be selected according to angles of inclination and/or cross section in order to be able to react to different qualities with different tabletting materials. This means that the tabletting machines obtained, i.e. tabletting machines equipped with such filling shoes, are particularly flexible in use. In addition, the variable angles of inclination and/or cross-sections can ensure venting of the powder material. This can significantly reduce the amount of air that enters the die bores or openings together with the powder, resulting in more homogeneous pellets or significantly reducing the number of defective pellets.

In a further embodiment of the invention, it is preferred that a non-rotating adapter is arranged between the filling tube and the covering device. This adapter preferably forms the transition between the rotating lid and the non-rotating filling tube through which the powder material preferably enters the filling device.

It is particularly preferred in the terms of the invention that the filling device comprises sealing devices, wherein the sealing devices are designed to prevent the leakage of tabletting material in the area of the filling shoe base plate and/or in a transition area between the covering device and the filling tube adapter. This avoids undesirable loss of powder material and material that has not been pressed can be collected inside the tabletting machine and reused if necessary. In particular, it is preferred that seals are provided in the area of the bearing of the drive shaft, which is advantageous for sealing the cone against the drive shaft. In addition, seals may be provided in the area of the transition between the rotating hopper and the stationary filling tube, this transition preferably being formed by a filling tube adapter. Preferably the lid rotates within a filling shoe base plate, whereby the transition between this base plate and the rotating hopper may also be provided with seals to prevent leakage of the powder material.

The invention is described in more detail using the following figures; it shows:

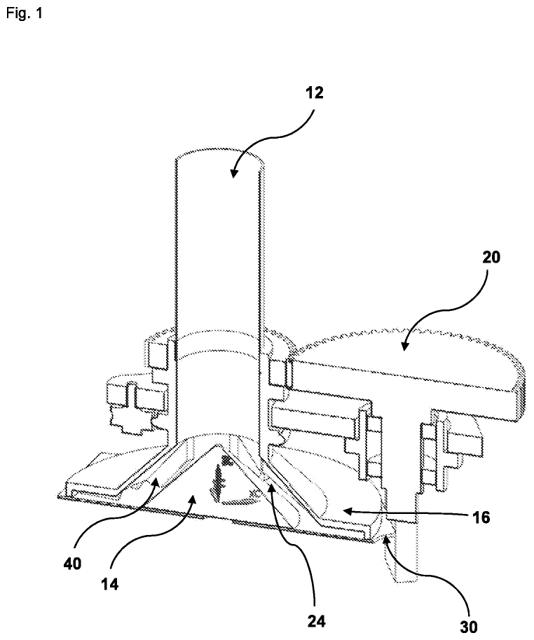

FIG. 1 A preferred design of the filling device with a drive located above the filling device.

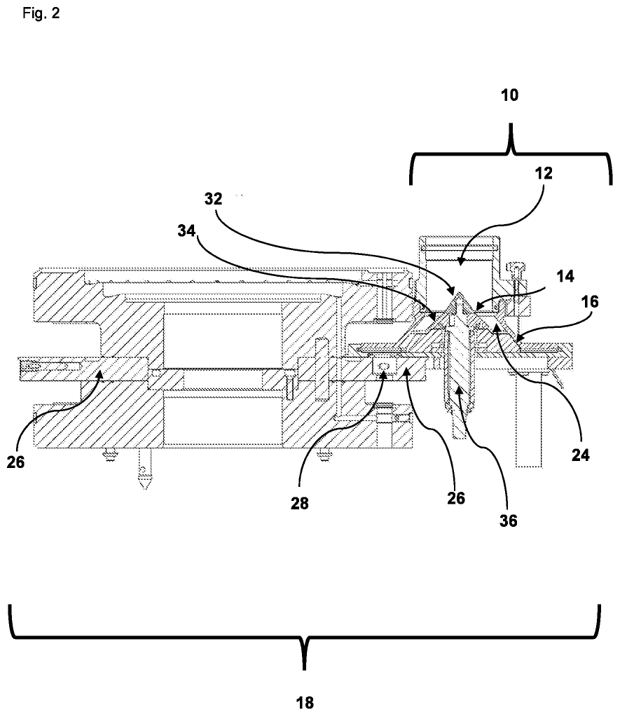

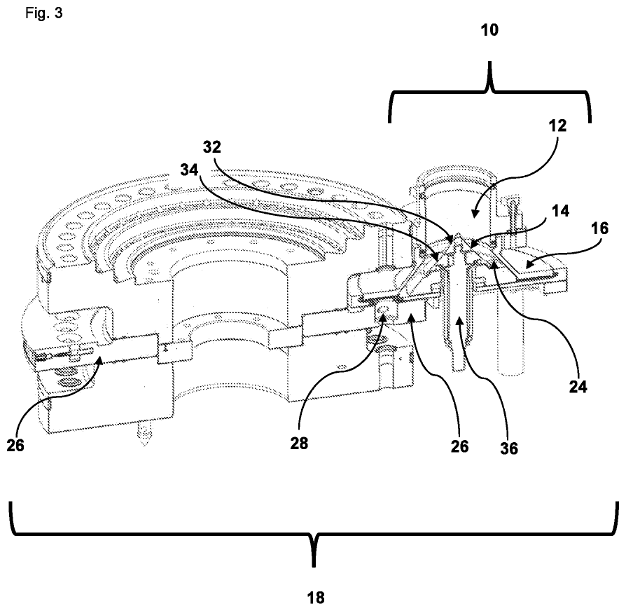

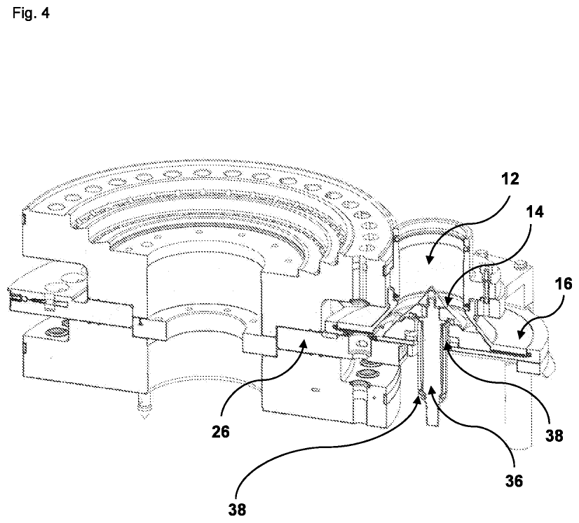

FIGS. 2 to 4 The preferred design of a filling device with a drive located below the filling device.

FIG. 1 shows a filling tube (12) for a filling device (10), the filling device (10) comprising a cone (14) and a lid (16). The tabletting machine (18) comprises drive means (20) which transmit the rotary movement of the drive means (20) to the lid (16), for example by means of a bridge. In the sense of the invention, the bridge can preferably be referred to as coupling means (22) or coupling (not shown). The drive means (20) can, for example, be realized by a belt drive or a gear drive. In the example of the invention shown in FIG. 1, the cone (14) is made in one piece, whereby this cone (14) preferably does not rotate. The side walls of the funnel-shaped lid (16) are preferably designed to correspond to the outer surfaces of the cone (14) or the cone components, whereby the term “correspond” in the sense of the invention preferably means that the side walls of the lid (16) and the outer surfaces of the cone (14) run completely or in places parallel to one another. It is preferred that the area between the side walls of the lid (16) and the outer surfaces of the cone (14) is referred to as the gap or flow channel section (24) through which the powder material passes to the die table (26). There the powder material is pressed into pellet in the die bores and/or openings (28). The hopper (16) rotates preferably within a base plate (30) of the filling device (10).

FIGS. 2 to 4 show preferred versions of the invention with a drive (20) arranged below the filling device (10). In the design example shown in FIG. 2, the cone (14) is designed in two parts, with the cone tip (32) being able to rotate and the truncated cone (34) being non-rotating. For example, the cone tip (32) may be internally connected to the drive shaft (36), causing the cone tip (32) to rotate. The cone tip (32) is further connected to the coupling means (22, not shown) with the hopper (16), whereby the rotation of the drive shaft (36) is transmitted to the hopper (16). In other words, in the sense of the invention, it is preferred that the coupling means (22) are arranged to transmit the rotational movement of the drive shaft (36) to the covering device (16).

FIGS. 2 to 4 also show the die plate (26) and the openings (28) in which the powder material is filled. The drive shaft (36) can, for example, be mounted (38) and provided with seals, whereby seals can, for example, also be provided in the region of the transition between the rotating funnel (16) and filling tube (12). This transition can be realized, for example, with a filling tube adapter. Guiding means (40) inside the filling device (10) facilitate the conveying of the tabletting material inside the filling device (10).

### REFERENCE CHARACTER LIST

10 filling device
12 filling tube
14 cone
16 lid or covering device
18 tabletting machine
20 drive means or drive unit
22 coupling means
22 gap or flow channel section
24 die table
20
26 die bores and openings
28 base plate
32 cone tip
34 truncated cone
36 drive shaft
38 bearings
40 guiding means

1. Filling device (10) for a tabletting machine (18) comprising a covering device (16) and a cone (14), wherein a gap (24) is formed between the covering device (16) and the cone (14), said gap (24) being designed to guide tabletting material from a filling tube (12) of the filling device (10) into a region of die openings (28) of a die table (26),
characterised in that
the covering device (16) is rotatably formed and the filling device (10) comprises a drive unit (20) for generating the rotational movement of the covering device (16).

2. Filling device according to claim 1
characterised in that
the cone (14) comprises a cone tip (32) and the filling tube (12) of a material feed is arranged centrally above the cone tip (32) and/or the filling tube (12) is arranged centrally with respect to an inlet opening of the covering device (16).

3. Filling device (10) according to claim 1
characterized in that
the drive unit (20) is arranged above the covering device (16).

4. Filling device (10) according to claim 1
characterized in that
the drive unit (20) is formed by a gear drive and/or a belt drive.

5. Filling device (10) according to claim 1
characterized in that
the drive unit (20) is arranged below the filling device (10).

6. Filling device (10) according to claim 5
characterised in that
the filling device (10) comprises a drive shaft (36) adapted to transmit rotational movement of the drive unit (20) to the covering device (16).

7. Filling device (10) according to claim 6
characterized in that
the covering device (16) and the drive shaft (36) are connected to each other by coupling means (22).

8. Filling device (10) according to claim 1 one or more of the previous
characterized in that
the filling device (10) comprises a bearing housing (38) for mounting the covering device (16).

9. Filling device (10) according to claim 1
characterised in that
the cone (14) is formed in at least two parts and comprises at least one truncated cone (34) and one cone tip (32).

10. Filling device (10) according to claim 9
characterized in that
the cone tip (32) is rotatably formed.

11. Filling device (10) according to claim 8
characterised in that
the cone tip (32) is connected to the drive shaft (36) and rotates in the same direction as the covering device (16).

12. Filling device (10) according to claim 1
characterized in that
the cone (14) comprises different portions, the different portions having different cross-sections and/or pitch angles.

13. Filling device (10) according to claim 1
characterized in that
the filling device (10) has no impeller and/or agitator blade.

14. Filling device (10) according to claim 1
characterized in that
a non-rotating adapter is disposed between filling tube (12) and covering device (16).

15. Filling device (10) according to claim 1
characterized in that
the filling device (10) comprises sealing means, said sealing means being adapted to prevent tabletting material from emerging in the region of the die openings (28) of the die table (26) and/or in a transition region between the covering device (16) and the filling tube adapter.
